(19) United States
(12) Patent Application Publication
(10) Pub. No.: US 2026/0281866 A1
(43) Pub. Date: Sep. 17, 2026

(54) DEVICES, METHODS AND APPARATUSES FOR DATA VOLUME PREDICTION

(71) Applicant: Nokia Technologies Oy, Espoo (FI)

(72) Inventors: Ethiraj ALWAR, Bangalore (IN); Anna PANTELIDOU, Antony (FR)

(21) Appl. No.: 19/471,348

(22) PCT Filed: Mar. 6, 2024
(86) PCT No.: PCT/EP2024/055777

§ 371 Date: Sep. 30, 2025

(30) Foreign Application Priority Data
Apr. 6, 2023 (IN) 202311025969

(51) Int. Cl. H04W 40/18

(52) U.S. Cl. CPC H04W 40/18

(57) ABSTRACT

Embodiments of the present disclosure disclose a solution for data volume prediction. In an example aspect, a first network device receives, from a second network device, a request for information at least comprising predicted data volume associated with at least one terminal device to be on or on at least one trajectory from a cell associated with the first network device to a cell associated with the second network device. Based on receiving the request, the first network device obtains the information. Then first network device transmits the information to the second network device. With the embodiments of the present disclosure, energy saving, load balancing, mobility optimization may be improved in a communication network.

### FIELD

Various example embodiments relate to the field of communication, and in particular, to devices, methods, apparatuses and a computer readable storage medium for data volume prediction.

### BACKGROUND

With the development of communication technology, artificial intelligence (AI)/machine learning (ML) functional framework has been introduced to improve communication performance. A new study item (SI) for the AI/ML functional framework is to study the high level principles for the enablement of AI in radio access network (RAN) and the functional framework including the AI functionality and the inputs and outputs needed by an ML algorithm. The SI aims to identify the data needed by an AI function in the input and the data that is produced in the output, as well as the standardization impacts at a node in the existing architecture or in the network interfaces to transfer this input or output data through them. The use cases of energy saving, load balancing, mobility optimization or traffic steering have been agreed to be studied first. It may be beneficial to enhance the AI/ML functional framework to improve system performance.

### SUMMARY

In general, example embodiments of the present disclosure provide devices, methods, apparatuses and computer readable storage medium for data volume prediction.

In a first aspect, there is provided a first network device. The first network device comprises at least one processor storing instructions that, when executed by the at least one processor, cause the first network device at least to: receive, from a second network device, a request for information at least comprising predicted data volume associated with at least one terminal device to be on or on at least one trajectory from a cell associated with the first network device to a cell associated with the second network device; obtain the information based on receiving the request; and transmit the information to the second network device.

In a second aspect, there is provided a second network device. The second network device comprises at least one processor; and at least one memory storing instructions that, when executed by the at least one processor, cause the second network device at least to: transmit, to a first network device, a request for information at least comprising predicted data volume associated with at least one terminal device to be on or on at least one trajectory from a cell associated with the first network device to a cell associated with the second network device; receive the information from the first network device; and apply the information.

In a third aspect, there is provided a method. The method comprises receiving, at a first network device from a second network device, a request for information at least comprising predicted data volume associated with at least one terminal device to be on or on at least one trajectory from a cell associated with the first network device to a cell associated with the second network device; obtaining the information based on receiving the request; and transmitting the information to the second network device.

In a fourth aspect, there is provided a method. The method comprises transmitting, at a second network to a first network device, a request for information at least comprising predicted data volume associated with at least one terminal device to be on or on at least one trajectory from a cell associated with the first network device to a cell associated with the second network device; receiving the information from the first network device; and applying the information.

In a fifth aspect, there is provided an apparatus. The apparatus comprises means for receiving, at a first network device from a second network device, a request for information at least comprising predicted data volume associated with at least one terminal device to be on or on at least one trajectory from a cell associated with the first network device to a cell associated with the second network device; means for obtaining the information based on receiving the request; and means for transmitting the information to the second network device.

In a sixth aspect, there is provided an apparatus. The apparatus comprises means for transmitting, at a second network to a first network device, a request for information at least comprising predicted data volume associated with at least one terminal device to be on or on at least one trajectory from a cell associated with the first network device to a cell associated with the second network device; means for receiving the information from the first network device; and means for applying the information.

In a seventh aspect, there is provided a non-transitory computer readable medium comprising program instructions for causing an apparatus to perform at least the method according to any one of the above third or fourth aspect.

In an eighth aspect, there is provided a computer program comprising instructions, which, when executed by an apparatus, cause the apparatus at least to: receive, from a second network device, a request for information at least comprising predicted data volume associated with at least one terminal device to be on or on at least one trajectory from a cell associated with the first network device to a cell associated with the second network device; obtain the information based on receiving the request; and transmit the information to the second network device.

In a ninth aspect, there is provided a computer program comprising instructions, which, when executed by an apparatus, cause the apparatus at least to: transmit, to a first network device, a request for information at least comprising predicted data volume associated with at least one terminal device to be on or on at least one trajectory from a cell associated with the first network device to a cell associated with the second network device; receive the information from the first network device; and apply the information.

In a tenth aspect, there is provided a first network device. The first network device comprises receiving circuitry configured to receive, from a second network device, a request for information at least comprising predicted data volume associated with at least one terminal device to be on or on at least one trajectory from a cell associated with the first network device to a cell associated with the second network device; obtaining circuitry configured to obtain the information based on receiving the request; and transmitting circuitry configured to transmit the information to the second network device.

In a tenth aspect, there is provided a second network device. The second network device comprises transmitting circuitry configured to transmit, to a first network device, a request for information at least comprising predicted data volume associated with at least one terminal device to be on or on at least one trajectory from a cell associated with the first network device to a cell associated with the second network device; receiving circuitry configured to receive the information from the first network device; and applying circuitry configured to apply the information.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example network environment in which example embodiments of the present disclosure may be implemented;

FIG. 1B illustrates an example functional framework for RAN intelligence related to some embodiments of the present disclosure;

FIG. 1C illustrates example trajectories among cells related to some embodiments of the present disclosure;

FIG. 1D illustrates an example RAN node level trajectory related to some embodiments of the present disclosure;

FIG. 1E illustrates an example cell level trajectory related to some embodiments of the present disclosure;

FIG. 1F illustrates an example beam level trajectory related to some embodiments of the present disclosure;

FIG. 2 illustrates an example signaling chart illustrating an example process according to some embodiments of the present disclosure;

FIG. 3 illustrates an example chained ML model according to some embodiments of the present disclosure;

FIG. 4 illustrates an example chained ML model in split architecture according to some embodiments of the present disclosure;

FIG. 5 illustrates an example process according to some embodiments of the present disclosure;

FIG. 6 illustrates an example process in non-split architecture according to some embodiments of the present disclosure;

FIG. 7 illustrates a flowchart of a method implemented at a first terminal device according to some embodiments of the present disclosure;

FIG. 8 illustrates a flowchart of a method implemented at a second terminal device according to some other embodiments of the present disclosure;

FIG. 9 illustrates a simplified block diagram of an apparatus that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UTE” may be used interchangeably.

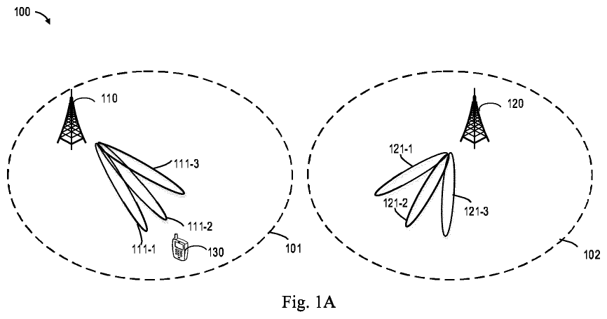

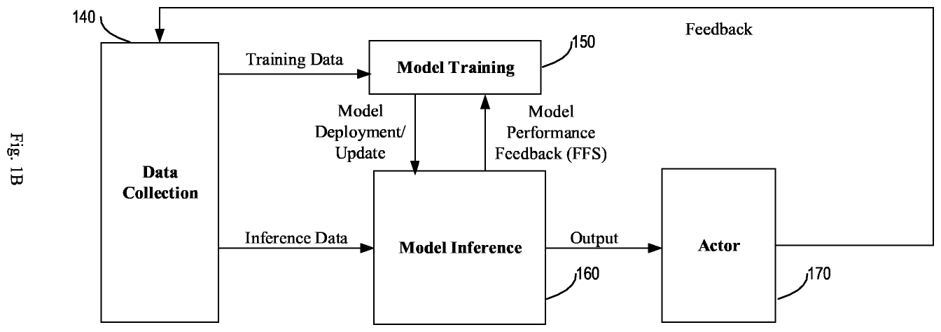

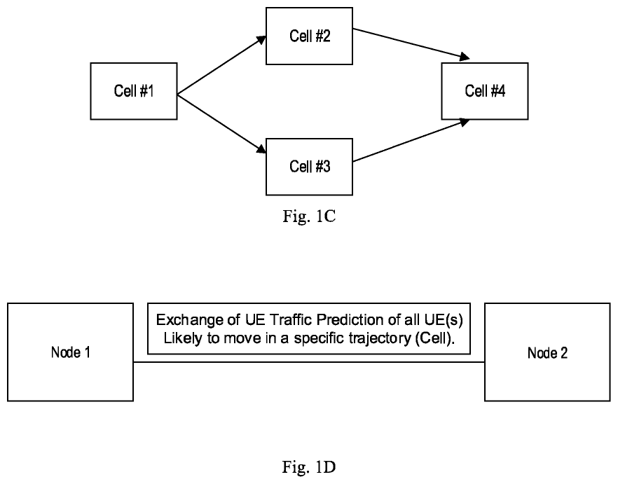

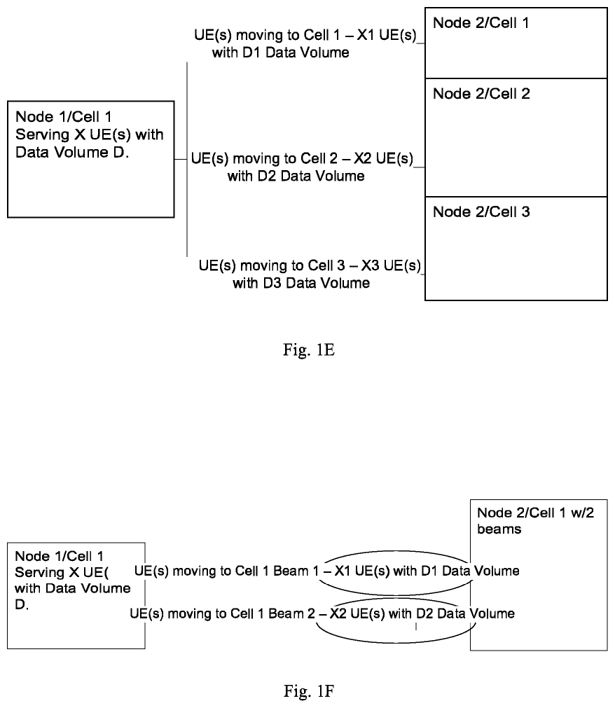

FIG. 1A illustrates an example network environment 100 in which example embodiments of the present disclosure may be implemented. The environment 100, which may be a part of a communication network, comprises terminal devices and network devices.

As illustrated in FIG. 1A, the communication network 100 may comprise a first network device 110 (hereinafter may also be referred to as network device 110 or gNB 110), a second network device 120 (hereinafter may also be referred to as network device 120 or gNB 120). The communication network 100 may further comprise a terminal device 130. The network device 110 may manage a cell 101, and the network device 120 may manage a cell 102. The terminal device 130 may communicate with the first network device 110 in the coverage of the cell 101 via a beam 111-1/111-2/111-3 provided by the first network device 110. The terminal device 130 may also communicate with the second network device 120 in the coverage of the cell 102 via a beam 122-1/122-2/122-3 provided by the second network device 120.

In some embodiments, the terminal device 130 may be handover from the first network device 110 to the second network device 120. The terminal device 130 may move cross from the cell 101 to the cell 102 or from the beam 111-1 to the beam 122-1.

It is to be understood that the number of network devices, terminal devices, cells and beams is only for the purpose of illustration without suggesting any limitations. The system 100 may include any suitable number of network devices, terminal devices, cells and beams adapted for implementing embodiments of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

Anew study item (SI) for the AI/ML functional framework is to study the high level principles for the enablement of AI in RAN and the functional framework including the AI functionality and the inputs and outputs needed by an ML algorithm. The SI aims to identify the data needed by an AI function in the input and the data that is produced in the output, as well as the standardization impacts at a node in the existing architecture or in the network interfaces to transfer this input or output data through them. The use cases of energy saving, load balancing, mobility optimization or traffic steering have been agreed to be studied first.

FIG. 1B illustrates an example functional framework for RAN intelligence related to some embodiments of the present disclosure. As shown in FIG. 1B, the functional framework comprises a data collection module 140, a model training module 150, a model inference module 160 and an actor module 170. The data collection module 140 provides training data to the model training module 150, and provides inference data to the model inference module 160. The model training module 150 transmits model deployment or model update to the model inference module 160, and the model inference module 160 transmits model performance to the model training module 150. The model inference module 160 further transmits output to the actor module 170, then the actor module 170 provides feedback to the data collection module 140 to capture the effect of the ML Model in network performance.

The present disclosure is focus on a consolidated view of all UE(s) in a given cell level trajectory and the associated traffic. FIG. 1C illustrates example trajectories among cells related to some embodiments of the present disclosure. As shown in FIG. 1C, there are two trajectories (1-2-4/1-3-4) from Cell #1 to Cell #4 through either Cell #2 or Cell #3. ML based algorithms are used to predict the number of UE(s) from cell #1 with trajectory (1-2-4) or (1-3-4) as well as the corresponding data volume at a given time. Such a prediction enables the target nodes (Cell #2 and Cell #3) to be aware of upcoming resource needs so that they can do any needed preparation pro-actively. That would benefit to network energy saving or mobility load balancing use cases to give some examples.

AIML enabled use cases such as network energy saving or load balancing involve a set of UE(s) getting offloaded to another node, cell, or beam. However, there exist no methods that enable RAN nodes predict and exchange overall data volume of a number of UE(s) moving in a certain trajectory involving RAN nodes or cells or beams. Trajectory associated traffic indicates the total data volume associated with all UE(s) moving in a specific trajectory.

Whenever a given node has to execute an action such as network energy saving or load balancing, there is no method to send the trajectory associated traffic information to the other impacted nodes to enable them to be aware of the incoming load. Without this information, the nodes have to allocate resources instantly after the offloading action is executed and hence will not be able to guarantee the success of resource allocation or overall performance.

FIG. 1D illustrates an example RAN node level trajectory related to some embodiments of the present disclosure. As shown in FIG. 1D, two nodes 1 and node 2. However, it's not possible for node 2 to request the total UE traffic (data volume) of UE(s) moving in a specific trajectory from node 1. The specific trajectory comprises cell 1/node 1 to cell 1/node 2 or cell 2/node 1 to cell 1/node 2.

FIG. 1E illustrates an example cell level trajectory related to some embodiments of the present disclosure. As shown in FIG. 1E, the UE traffic served by a cell 1 of node 1 moves across 3 possible cell level trajectories. The trajectories comprise cell 1 of node 1 1 to cell 1 of node 2, cell 1 of node 1 to cell 2 of node 2 and cell 1 of node 1 to cell 3 of node 2. A proportion X1 of UEs with Data Volume D1 follows the first trajectory, a proportion X2 of UEs with Data Volume D2 follows the second trajectory and a proportion X3 of UEs with Data Volume D3 follows the third trajectory.

FIG. 1F illustrates an example of beam level trajectory related to some embodiments of the present disclosure. As shown in FIG. 1F, the UE traffic served by cell 1 of node 1 1 moves across 2 possible beam level trajectories. The trajectories comprise beam 1 of cell 1 of node 1 to beam 1 of cell 1 of node 2, and beam 1 of cell 1 of node 1 to beam 2 of cell 1 of node 2. Again in this scenario X1 UEs with Data Volume D1 follow the first trajectory and X2 UEs with Data Volume D2 follow the second trajectory.

Anode does not have a holistic view of the UE(s) and the associated incoming traffic in a given trajectory in a future time window, i.e., the total data volume associated with all the UEs in a trajectory and expected time spent. Hence, the target node is not able to make any assessment of the resource needs and accordingly plan any possible pro-active actions to best serve such needs. This becomes even more relevant when a given node or cell is currently loaded. Some of the possible actions may comprise activating new capacity cells to ensure that the incoming UE(s) traffic can be served. These capacity cells can be added as secondary cells to the UEs. Some of the possible actions may further comprise load balancing handover to ensure that the incoming UE(s) traffic can be served in the specific cells.

According to some embodiments of the present disclosure, a solution is provided for data volume prediction associated with a predicted UE Trajectory. In this solution, a first network device receives, from a second network device, a request for information at least comprising predicted data volume associated with at least one terminal device to be on or on at least one trajectory from a cell associated with the first network device to a cell associated with the second network device. Based on receiving the request, the first network device obtains the information. Then first network device transmits the information to the second network device. As such, in embodiments of the present disclosure, the first network device may predict trajectory based data volume and exchange the trajectory based data volume with the second network device. Then the second network device may allocate additional resources based on the trajectory based data volume to handle the incoming load. Thereby energy saving, load balancing, mobility optimization may be improved.

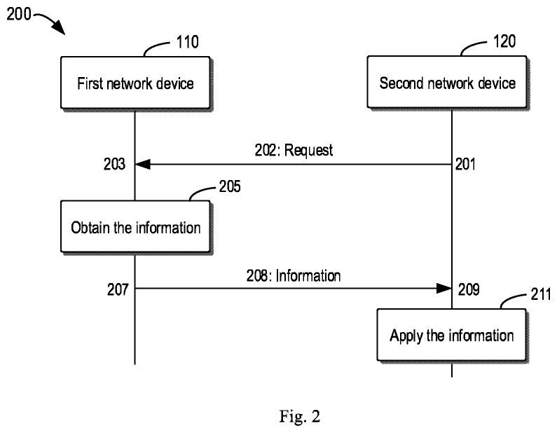

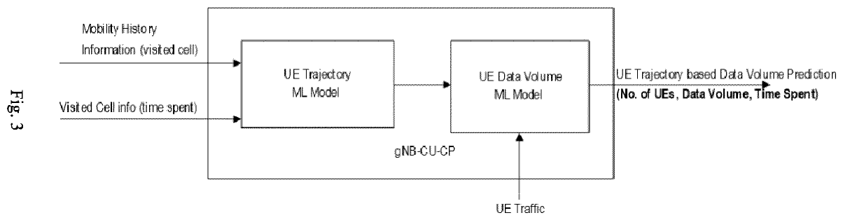

Example embodiments of the present disclosure for data volume prediction will be described below with reference to FIGS. 2-10.

FIG. 2 illustrates an example signaling chart illustrating an example process 200 according to some embodiments of the present disclosure. For the purpose of discussion, the process 200 will be described with reference to FIG. 1A. The process 200 may involve the first network device 110 and the second network device 120. However, each network device 110, 120 may perform their own respective steps of the process 200. It would be appreciated that although the process 200 has been described in the communication environment 100 of FIG. 1A, this process 200 may be likewise applied to other communication scenarios with similar issues. Through the process 200, the prediction and exchange among neighboring NG-RAN nodes of data volume information associated with all the UEs in a certain trajectory (cell-based or beam-based) is enabled. This solution enables improved resource management in network energy saving or mobility load balancing.

In the process 200, the second network device 120 transmits 201 a request 202 for information at least comprising predicted data volume to the first network device 110. That is, the request 202 may indicate to the first network device 110 that the second network device 120 requests information from the first network device. The requested information may comprise predicted data volume (can be referred to also as predicted data volume information). For example, the request may indicate that information comprising at least predicted data volume is requested. The predicted data volume herein may refer to predicted data volume associated with at least one terminal device to be on or on at least one trajectory from a cell associated with the first network device to a cell associated with the second network device. In other words, the at least one terminal device may be handed over from the cell of the first network device to the cell of the second network device, or it may already be in the process of handover. It is to be understood that this is merely an example, and the second network device 120 may transmit the request to more network devices. In some embodiments, the request may be received via an XnAP interface.

For example, the request may indicate the at least one trajectory or at least information based on which UE(s) with corresponding trajectories may be determined. For example, the request may comprise or indicate a list of cells. The list of cells may indicate at least a part of predicted trajectory for which the second network device 120 is interested in. For example, if the message (i.e. request 202) indicates a certain cell (e.g. cell 2) in the cell list (which may comprise one or more cells), it indicates that the second network device 120 is interested in (i.e. requests) the consolidated UE traffic of all UE(s) in any trajectory from any cell of the first network device 110 to cell 2 of the second network device 120. For example, if the first network device 110 has three cells, the second network device 120 may request information on all UEs in any trajectory involving the first network device 110/cell1 to the second network device 120/cell2, the first network device 110/cell2 to the second network device 120/cell2 and the first network device 110/cell3 to the second network device 120/cell2. Thus, in some examples, the request 202 may indicate the at least one trajectory or at least a part of that trajectory as one or more cells. For example, these cells may be provided by the second network device 120. The first network device 110 may determine that a given UE should be taken into account in the predicted data volume if UE's trajectory is or is going to be at least partially within the indicated one or more cells.

In some embodiments, the information (i.e. the requested information) may further comprise a number of the at least one terminal device, expected time when the at least one terminal device is offloaded from a cell associated with the first network device to a cell associated with the second network device, or any combination of two or more of the above-mentioned items.

In some embodiments, the second network device 120 may transmit the request in the case that the at least one cell of the second network device is to be deactivated. For example, the second network device 120 transmits the request based on determining that the at least one cell of the second network device is to be deactivated. In some embodiments, the second network device 120 may transmit the request in the case that at least one cell of the second network device is to be activated. For example, the second network device 120 transmits the request based on determining that the at least one cell of the second network device is to be activated. In both of these cases, the second network device 120 may indicate (in the request 202) the cell that is to be deactivated or activated.

In an example, the second network device 120 (as a given RAN Node) may be triggered to indicate the list of targets (cells or beams) for which it would like to get information from its neighbor's trajectory associated traffic. The second network device 120 may be triggered based on event-based approach, and the event-based approach may comprise load based trigger (when the load of a given cell exceeds a particular threshold) or network energy saving based trigger (cell de-activation or activation).

In another example, a node may send the information to its neighbor nodes upon certain triggers e.g. when a node is about to de-activate its cell it can inform all its neighbor nodes about the trajectory associated traffic.

Continuing with reference to FIG. 2, based on receiving 203 the request 202, the first network device 110 obtains 205 the information (i.e. the information that is requested). In some embodiments, the request may be indicative of at least one cell or beam of the second terminal device.

In some embodiments, the first network device may obtain or determine at least one cell or beam of the second network device from the request or on the basis of the request. In some embodiments, the first network device may determine the at least one trajectory which is associated with at least one cell or beam of the first network device as well as the at least one cell or beam of the second network device indicated in the request.

In some embodiments, in order to obtain the information, the first network device 110 may use a trajectory model to determine the at least one terminal device which is to be on or on the at least one trajectory among a plurality of terminal devices served by the first network device. Then the first network device 110 may use a data volume model to determine the information associated with the at least one terminal device. In other words, the first network device 110 may infer the list of terminal devices that will follow or already follow a trajectory from the first network device.

In some embodiments, in order to determine the at least one terminal device, for a terminal device among the plurality of terminal devices, the first network device 110 may determine whether a predicted trajectory of the terminal device is one of the at least one trajectory. In some embodiments, in the case that the predicted trajectory of the terminal device is one of the at least one trajectory, the first network device 110 may determine that the terminal device is one of the at least one terminal device. In some embodiments, if the predicted trajectory is from first network device's cell to second network device's cell, then the terminal device should be indicated to the second network device.

In some embodiments, the first network device 110 may obtain mobility history information comprising visited cell/beam information and a time spent from the terminal device; and then the first network device 110 may input the mobility history information and the visited cell/beam information into the trajectory model, the predicted trajectory of the terminal device may be determined. In some embodiments, in order to determine the information, the first network device 110 may provide an output of the trajectory model into the data volume model as an input.

As described above, a chained ML model may be used to predict the trajectory based data volume by feeding the output of a first ML model (i.e., the trajectory model) as input to a second ML model (i.e., the data volume model). A chained ML model involves more than one ML model inference. In case of ML model chaining, more than one ML models are involved i.e., the output of one model is used as input to the subsequent model. A node has to perform both the ML Model inferences before sending output to another requesting node.

According to some example embodiments, the first network device 110 and the second network device 120 may be network nodes, such as NG-RAN nodes.

FIG. 3 illustrates an example chained ML Model according to some embodiments of the present disclosure. As shown in FIG. 3, the first ML model is the UE trajectory ML model which infers list of UEs in a trajectory (a source cell to a target cell). The second ML model is the UE data volume ML model which infers the data volume for a given UE. The output of UE trajectory ML model gives the list of UEs while this is used as input to the UE data volume ML model. The output parameter is the UE trajectory based data volume prediction. The UE trajectory-based data volume may comprise the number of the UEs, data volume and time spent.

In some embodiments, for a terminal device among the at least one terminal device, the first network device 110 may determine an individual predicted data volume using the data volume model and traffic information of the terminal device. Then the first network device 110 may determine the predicted data volume based on a sum of at least one individual predicted data volume of the at least one terminal device. The individual predicted data volume indicates data volume for a given terminal device. Thus, the predicted data volume may be obtained by summing up the individual data volumes of one or more terminal device(s). For example, if individual predicted data volume of first UE and individual predicted data volume of second UE is determined, the predicted data volume (may be sometimes referred to as predicted total data volume) may be obtained by summing up the individual data volumes of the first and second UEs.

In the chained ML Model, for each trajectory requested, ML model inference of all UE(s) is performed. For each UE in the trajectory, ML model inference of data volume is performed. Then the total predicted data volume of all UE(s) in a trajectory is calculated.

In some embodiments, the trajectory model may be deployed at one of a control plane (CP) of a centralized unit (CU) of the first network device, a user plane (UP) of the CU of the first network device, or a distributed unit (DU) of the first network device; and the data volume model may be deployed at another one of the CP of the CU of the first network device, the UP of the CU of the first network device, or the DU of the first network device.

In split architecture, two ML model inferences can be located in two different logical nodes. Two ML Models may be located in different logical entities, e.g. gNB-DU, gNB-CU-CP, and gNB-CU-UP.

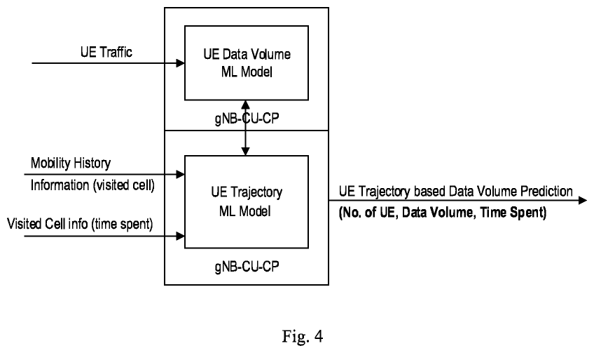

FIG. 4 illustrates an example chained ML model in split architecture according to some embodiments of the present disclosure. As shown in FIG. 4, the UE trajectory ML model is located in gNB-CU-CP and the UE data volume ML model is located in gNB-CU-UP. Hence, there is a need to enhance the E1AP procedures to send the intermittent output to the other logical node as input.

In some embodiments, in the first network device, the gNB-CU-CP may indicate the at least one terminal device determined based on the trajectory model to the gNB-CU-UP. Then the gNB-CU-UP may determine at least one individual predicted data volume of the at least one terminal device based on the data volume model. After that, the gNB-CU-UP may provide the at least one individual predicted data volume to the gNB-CU-CP. Then the gNB-CU-CP may determine the predicted data volume by summing the at least one individual predicted data volume. It is to be understood that the embodiment is one configuration of the possible model configurations, without suggesting any limitations as to the scope of the disclosure.

For example, in an example of split architecture, the data volume model is hosted in gNB-CU-UP. For each UE in the UE-List, the gNB-CU-CP triggers prediction by sending a request message over E1 interface. The procedure to be used for this request may be an existing E1AP procedure or a newly defined procedure. The message may contain the list of UEs for which the traffic prediction is needed. The gNB-CU-UP performs prediction for each UE using the ML model. The gNB-CU-UP then sends a message over E1 interface with the predicted traffic volume for each UE to the gNB-CU-CP. The procedure to be used to send the predicted traffic volume for each UE to gNB-CU-CP can be an enhancement of an existing procedure or a newly defined E1AP procedure. The gNB-CU-CP calculates the total data volume which is the sum of predicted data volume for each UE.

In some embodiments, the gNB-CU-CP may indicate the at least one terminal device determined based on the trajectory model to the gNB-CU-UP. Then the gNB-CU-UP may determine at least one individual predicted data volume of the at least one terminal device based on the data volume model. After that the gNB-CU-UP may determine the predicted data volume by summing the at least one individual predicted data volume. In other words, the summing the at least one individual predicted data volume may be summed at the gNB-CU-CP or the gNB-CU-UP.

In some embodiments, an output of the trajectory model may be provided to the data volume model as an input via an E1 interface or an F1 interface. In the event that the ML model is located in gNB-DU, ML model chaining between gNB-CU-CP and gNB-DU is needed which would necessitate enhancing F1 interface.

In some embodiments, a trajectory model inference may be done based on mobility history information of a plurality of terminal devices. In some embodiments, the mobility history information of a terminal device may comprise visited cells/beams of the terminal device and time spent by the terminal device in each of the visited cells/beams.

For example, the mobility history information (containing the visited cells and time spent on each cell) is reported from the UE. A data volume report is collected at the gNB-CU-UP. The gNB (gNB-CU-CP) collects reports containing the mobility history information which indicates the time spent in each cell visited. Table 1 shows the time spent in each cell visited.

TABLE 1
Time spent in each cell visited by the UE(s)

| UE Identity | Cell 1 (seconds) | Cell 2 (seconds) | Cell 3 (seconds) |
|---|---|---|---|
| UE1 | 200 | 300 | 100 |
| UE2 | 300 | 200 | 300 |
| UE3 | 400 | 400 | 400 |

The gNB (gNB-CU-UP) collects the total data volume consumed by the UE(s). This is collected at PDCP protocol layer. Table 2 shows the total data volume consumed by the UE(s).

TABLE 2
Total data volume consumed by the UE(s)

| UE | Data Volume | Data Volume | Data Volume |
|---|---|---|---|
| Identity | (Mbps) | (Mbps) | (Mbps) |
| UE1 | 2 | 3 | 1 |
| UE2 | 1 | 2 | 3 |
| UE3 | 4 | 4 | 4 |

In some embodiments, a data volume model inference may be done based on sets of data items of a plurality of trajectories. In some embodiments, a set of data items of a trajectory may comprise at least a list of cells/beams, a list of terminal devices, a count of terminal devices, expected average time spent, expected total data volume, or expected average data volume at a future time instance. In some embodiments, the data volume model inference may be done to predict at least one of a count of active terminal devices or a data volume on a given trajectory at a given time.

For example, the collected UE mobility history information is passed as input to the model. The ML model builds a relationship between the time spent in a cell and next cell visited. For each UE for which mobility history is collected, the data is categorized per UE trajectory as table 4 (first 3 columns). The last column of table 4 corresponds to the total data volume of the corresponding UE(s). The gNB-CU-UP reports the data usage per UE using the data usage report over E1 interface. The gNB-CU-CP calculates the total data volume using the per-UE data usage report of those corresponding UE(s). It is to be understood that the trajectory model is used and no prediction of data volume is involved. In some embodiments, the data volume model may be used to determine predicted data volume for a requested UE trajectory. In some embodiments, the trajectory model may be used to determine actual data volume for a predicted UE trajectory. In some embodiments, both the data volume model and the trajectory mode may be used to determine predicted data volume for a predicted UE trajectory.

TABLE 4
Trajectory based total data volume for the UE(s)

| UE Trajectory | Time stamp | List of UE(s) | Total Data Volume |
|---|---|---|---|
| Cell 1-Cell 2 | XX:YY:ZZ | UE1, UE2 | DV of UE1 + DV of |
| | | | UE2 |
| Cell 1-Cell 3 | AA:BB:CC | UE3 | DV of UE3 |

With the above information, the gNB-CU-CP may model the set of UE(s) that are traversing a UE trajectory and the corresponding data volume at a given time stamp. With such ML model, it is possible for the gNB to predict the active UE count or data volume moving a specific UE trajectory at a given time. A possible method for the gNB to predict at a future period (e.g. peak hours), how the UE(s) and hence the associated traffic will follow the trajectory is provided next: the gNB-CU-CP first makes an inference request to identify the list of UE(s) that will follow a trajectory. This input is then passed on to another ML model in gNB-CU-UP to predict the data volume associated with each of these UE(s). Accordingly, gNB now has the predicted total data volume in a UE trajectory.

With such a prediction, a RAN node is enabled to exchange predicted trajectory and traffic information to other RAN Nodes. This can be realized through an XnAP protocol via Xn interface.

Reference is made back to FIG. 2, the first network device 110 transmits the information 208 to the second network device 120. In some embodiments, the information may be transmitted via Xn interface. The information 208 may comprise the information requested by the request 202. For example, the information may comprise the predicted data volume of UE(s) with relevant trajectory or trajectories.

After receiving 209 the information 208 from the first network device 110, the second network device 120 may apply 211 the information.

In some embodiments, based on the information, the second network device 120 may perform at least one operation for cell activation, load balancing, energy saving, or any combination of two or more of the above-mentioned items. Such action(s) may be understood to be comprised in step 211.

In some embodiments, in the case that a sum of the predicted data volume and a data volume served by the second network device is greater than a data volume capacity of the second network device (i.e. without the at least one cell active), the second network device 120 may activate at least one cell of the second network device. Thus, the second network device 120 may activate the at least one cell of the second network device based at least on the information 208 (e.g. predicted data volume) which it may receive from the first network node 110. Activating a cell may mean that the cell is switched on, for example.

In some embodiments, the second network device 120 may deactivate at least one cell of the second network device based on the information 208. For example, in the case that a sum of the predicted data volume and a data volume served by the second network device is less or equal to a data volume capacity of the second network device without the at least one cell, the second network device 120 may deactivate at least one cell of the second network device.

In some embodiments, the predicted data volume itself is an indication of the incoming load to be served. The receiving node (i.e., the second network device 120) may use this metric itself to decide the action(s) (i.e. how to apply the information).

For example, total data volume capacity of a given node is equal to X Mbps/sec, currently served Data Volume is equal to Y Mbps/sec, predicted data volume from UE Trajectory is equal to Z Mbps/sec. If Y+Z>X, then it implies that the node needs additional capacity (additional cells or user plane capacity) to be able to serve the incoming load.

In some embodiments, the second network device 120 may determine energy cost based on measurements from the terminal devices and the predicted data volume using an energy cost model. Then the second network device 120 may determine energy efficiency based on the predicted data volume and the energy cost. In the case that the energy efficiency is improved, the second network device 120 may activate at least one cell of the second network device. In the case that the energy efficiency is not improved, the second network device 120 may skip activating at least one cell of the second network device.

For example, while a node may serve the additional load by activating additional capacity, it's also beneficial to calculate a cost related to energy, a commonly used metric is the energy efficiency (EE) metric which may be determined using the data volume (DV) and energy consumption (EC) as follows:

$${EE}_{MN} = \frac{{DV}_{MN}}{{EC}_{MN}} \qquad ( 1 )$$

wherein the EE_{MN,DV} refers to the energy efficiency of the second network device, the DV_{MN} refers to the predicted data volume received from the first network device, and the EC_{MN} refers to the energy consumption predicted at the second network device.

Once a node receives the predicted data volume from the UE trajectories, it can then perform the EE prediction as follows. First, the node may predict the first energy cost. The first energy cost corresponds to the energy consumption EC_{MN} described in the formula (1). For example, first energy cost can be predicted from an ML model using UE measurements and the data volume can be as inputs. Then, the node can calculate the second energy cost, the second energy cost corresponds to the energy efficiency EE_{MN,DV} described in the formula (1). For instance, calculate the predicted second energy cost using the predicted data volume (received from other nodes) and predicted first energy cost (ML model prediction in the local node). With this, a node can evaluate the additional cost for the incoming load in terms of first energy cost or second energy cost.

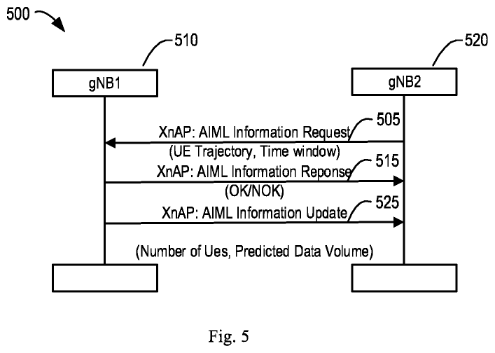

FIG. 5 illustrates an example process 500 according to some embodiments of the present disclosure. The process 500 may involve a gNB1 510, a gNB2 520. It is understood that the process 500 can be considered as a more specific example of the process 200 in FIG. 2. Thus, the gNB1 510 in FIG. 5 may be an example of the first network device 110 in FIG. 1A or 2 and the gNB2 520 in FIG. 5 may be an example of the second network device 120 in FIG. 1A or FIG. 2.

In the process 500, the gNB2 520 may initiate 505 a request message over Xn interface to request a prediction of the data volume from all the UE(s) that are likely to be handed over if one or more cell(s) of gNB2 520 are activated at an expected time in future.

As shown in FIG. 5, the gNB2 520 transmits 505 a request message to the gNB1 510 over Xn interface. This can be done through a new procedure or through enhancing an existing procedure. The request message comprises UE trajectory and a time window. The UE trajectory in the request message indicates a list of cells which are part of predicted UE trajectory. For example, if the request message indicates cell 2 in the cell list, it indicates that gNB2 520 is interested in the consolidated UE traffic of all UE(s) in any trajectory from any cell of gNB1 510 to cell 2 of gNB2 520. For example, if the gNB1 510 has three cells, the gNB2 520 is requesting information on all trajectories involving cell 1 of gNB1 510 to cell 2 of gNB2 520, cell 2 of gNB1 510 to cell 2 of gNB2 520 and cell 3 of gNB1 510 to cell 2 of gNB2 520.

After receiving the request message over Xn interface, the gNB1 510 transmits 515, a response message over Xn interface to the gNB2 520. This can be done through a new procedure or through enhancing an existing procedure. The response message may comprise an indication (e.g., OK) to indicate that the request was received successfully and that gNB2 520 is capable to provide the requested information. The response message may also comprise an indication (e.g., Not OK) to indicate that it is not capable to provide the requested information. This can also be a failure message. Then the gNB1 510 transmits the actual reported information in a XnAP message to the gNB2 520. In the reporting message over Xn interface, information related to a number of the UEs and predicted data volume is indicated. For example, gNB2 520 may send the reporting message over Xn interface with the prediction information i.e., number of UE(s) likely to be offloaded, predicted data volume, the expected time at which offloading may take place and the expected time of stay after the offloading.

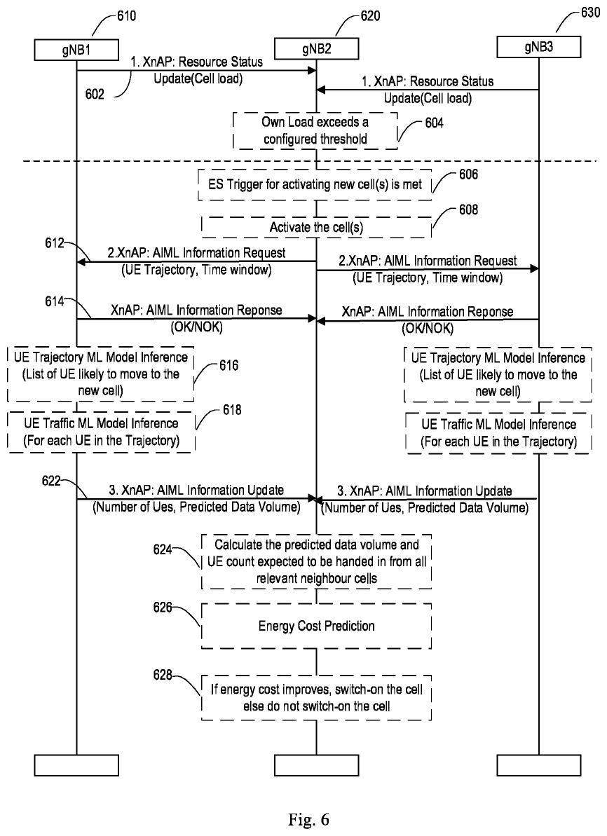

FIG. 6 illustrates an example process in non-split architecture according to some embodiments of the present disclosure. The process 600 may involve a gNB1 610, a gNB2 620, and a gNB3 630. It is understood that the process 600 can be considered as a more specific example of the process 200 in FIG. 2. Thus, the gNB1 610 and the gNB3 630 in FIG. 6 may be an example of the first network device 110 in FIG. 1A or 2 and the gNB2 620 in FIG. 5 may be an example of the second network device 120 in FIG. 1A or FIG. 2.

In the process 600, gNBs exchange the current data volume and predicted data volume at cell level amongst them. This can be done by enhancing an existing XnAP procedure or by defining a new procedure. As an example, gNB1 610, gNB2 620 and gNB3 630 are described in the process 600. It is understood that the process 600 can be considered as a more specific example of the process 200 in FIG. 2. Thus, the gNB1 610 and the gNB3 630 in FIG. 6 may be an example of the first network device 110 in FIG. 1A or 2, and the gNB2 620 in FIG. 6 may be an example of the second network device 120 in FIG. 1A or FIG. 2.

The gNB1 610 transmits 602 resource status update message over Xn interface to the gNB2 620, and the gNB3 630 also transmits a resource status update message over Xn interface to the gNB2 620. This is to provide cell load information to gNB2 620 from neighboring nodes. In the following, the actions performed by gNB3 630 or gNB 610 may be the same as the gNB2 620 and are therefore no longer described separately.

When the data volume exceeds 604 a configured threshold in one or more cells of gNB2 620, and prediction indicates that this is likely to continue for a specific duration in future time period (i.e. cell load condition prevails), thereby ES trigger for activating new cells may be met 606. The gNB2 620 has to evaluate if any new cells have to be activated to handle additional load that is likely to be moved from other gNBs (e.g. gNB1 610 and gNB3 630). In some embodiments, the gNB2 620 may activate 608 one or more new cell(s) using the legacy cell activation procedure.

Continuing with reference to FIG. 6, gNB2 620 sends 612 a request message over Xn interface to gNB1 610 and gNB3 630 requesting the estimated data volume prediction to the newly activated cell. The request message comprises at least one UE trajectory and a time window.

Upon receipt of the request message from the gNB2 620, the gNB1 610 and gNB3 630 transmit a response message to gNB1 610 to acknowledge that they are capable to continue with the reporting.

The gNB1 610 and gNB3 630 predict the UE data volume associated with all the UEs in a UE trajectory involving the indicated cells. gNB1 610 now does 616 ML inference using UE trajectory ML model (e.g. cell level or beam level). The inference output indicates the total number of UEs that are likely to move to target cell in gNB2 620.

For all these UEs, gNB1 610 then does 618 ML inference using the data volume ML model. For each UE in the UE-List, gNB1 610 triggers prediction and predicts the data volume. Such a prediction is performed for a specific time window during which the prediction is applicable. After that, the gNB1 610 calculates the total data volume which is the sum of predicted data volume.

The gNB1 610 and the gNB3 630 send 622 this information to the gNB2 620 using the reporting message over Xn interface including the predicted UE count, predicted data volume and the predicted time window.

The gNB2 620 is able to identify the cumulative additional data volume that is likely to be transferred. After receiving the reporting message from the gNB1 610 and the gNB3 630, the gNB2 620 may calculate the predicated data volume and UE count expected to be handed in from all relevant neighbor cells.

Based on this, gNB2 620 can execute in 626 additional ML inferences (e.g., prediction of an second energy cost that can be an energy efficiency (e.g., in bits per joule), an energy consumption (e.g., in joules), or a different metric defining e.g., energy consumption or an energy cost for a certain load) and identify actions to allocate additional resources (e.g. new capacity cell activation or load balancing or other energy saving actions) to ensure that the incoming load can be handled. If the predicted second energy cost defined improves, the gNB2 620 may switch-on 628 the cells. If the predicted second energy cost does not improve, the gNB2 620 may not switch-on the cells.

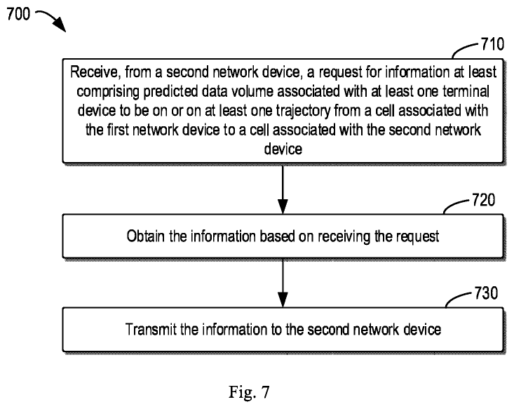

FIG. 7 illustrates a flowchart of method 700 implemented at the first network device 110 according to some embodiments of the present disclosure. For the purpose of discussion, the method 700 will be described from the perspective of the first network device 110 with reference to FIG. 1A. It is to be understood that method 700 may further include additional blocks not shown and/or omit some shown blocks, and the scope of the present disclosure is not limited in this regard.

At block 710, the first network device 110 receives a request for information at least comprising predicted data volume associated with at least one terminal device to be on at least one trajectory from the first network device to the second network device from a second network device. At block 720, the first network device 110 obtains the information based on receiving the request. At block 730, the first network device 110 transmits the information to the second network device.

In some embodiments, in order to obtain the information, the first network device may determine the at least one terminal device which is to be on or on the at least one trajectory among a plurality of terminal devices served by the first network device using a trajectory model, and determine the information associated with the at least one terminal device using a data volume model.

In some embodiments, in order to determine the at least one terminal device, the first network device may determine whether a predicted trajectory of the terminal device is one of the at least one trajectory for a terminal device among the plurality of terminal devices. Then the first network device may determine that the terminal device is one of the at least one terminal device based on determining that the predicted trajectory of the terminal device is one of the at least one trajectory.

In some embodiments, the first network device may obtain mobility history information and visited cell/beam information on the terminal device, and determine the predicted trajectory of the terminal device by inputting the mobility history information and the visited cell/beam information into the trajectory model.

In some embodiments, in order to determine the information, the first network device may obtain the information by providing an output of the trajectory model into the data volume model as an input.

In some embodiments, the first network device may further determine an individual predicted data volume based on the data volume model and traffic information of the terminal device for a terminal device among the at least one terminal device, and determine the predicted data volume based on a sum of at least one individual predicted data volume of the at least one terminal device.

In some embodiments, the trajectory model may be deployed at one of a control plane (CP) of a centralized unit (CU) of the first network device, a user plane (UP) of the gNB-CU of the first network device, or a distributed unit (DU) of the first network device; and the data volume model may be deployed at another one of the CP of the CU of the first network device, the UP of the CU of the first network device, or the DU of the first network device.

In some embodiments, in the first network device, the gNB-CU-CP may indicate the at least one terminal device determined based on the trajectory model to the gNB-CU-UP. Then the gNB-CU-UP may determine at least one individual predicted data volume of the at least one terminal device based on the data volume model. After that, the gNB-CU-UP may provide the at least one individual predicted data volume to the gNB-CU-CP. Then the gNB-CU-CP may determine the predicted data volume by summing the at least one individual predicted data volume.

In some embodiments, in the first network device, the gNB-CU-CP may indicate the at least one terminal device determined based on the trajectory model to the gNB-CU-UP. Then the gNB-CU-UP may determine at least one individual predicted data volume of the at least one terminal device based on the data volume model. After that the gNB-CU-UP may determine the predicted data volume by summing the at least one individual predicted data volume.

In some embodiments, an output of the trajectory model may be provided to the data volume model as an input via an E1 interface or an F1 interface.

In some embodiments, the trajectory model inference may be done based on mobility history information of a plurality of terminal devices; and the mobility history information of a terminal device may comprise visited cells/beams of the terminal device and time spent by the terminal device in each of the visited cells/beams.

In some embodiments, the data volume model inference may be done based on sets of data items of a plurality of trajectories. In some embodiments, a set of data items of a trajectory may comprise at least a list of cells/beams, a list of terminal devices, a count of terminal devices, expected average time spent, expected total data volume, or expected average data volume at a future time instance. In some embodiments, the data volume model inference may be done to predict at least one of a count of active terminal devices or a data volume on a given trajectory at a given time.

In some embodiments, the first network device may obtain at least one cell or beam of the second network device from the request, and determine the at least one trajectory which is associated with (i) at least one cell or beam of the first network device and (ii) the at least one cell or beam of the second network device indicated in the request.

In some embodiments, the information may further comprise a number of the at least one terminal device, expected time when the at least one terminal device is offloaded from a cell associated with the first network device to a cell associated with the second network device, or a combination the above-mentioned items.

In some embodiments, the request may be received via an Xn interface, the information may be transmitted via an Xn interface.

With the process 700, improved resource management in network energy saving or mobility load balancing is enabled.

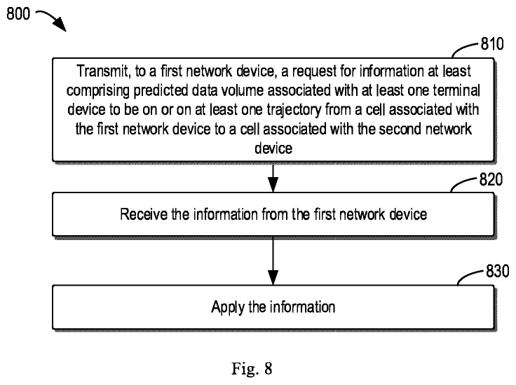

FIG. 8 illustrates a flowchart of a method 800 implemented at the second terminal device 120 in accordance with some embodiments of the present disclosure. For the purpose of discussion, the method 800 will be described from the perspective of the second terminal device 120 with reference to FIG. 1A. It is to be understood that method 800 may further include additional blocks not shown and/or omit some shown blocks, and the scope of the present disclosure is not limited in this regard.

In some embodiments, in order to transmit the request, the second network device may determine that at least one cell of the second network device is to be deactivated. In some embodiments, in order to transmit the request, the second network device may determine that at least one cell of the second network device is to be activated, or any combination of two or more of the above-mentioned items.

In some embodiments, in order to apply the information, the second network device may perform at least one operation for at least one of cell activation, load balancing, or energy saving based on the information.

In some embodiments, the at least one operation may comprise: based on determining that a sum of the predicted data volume and a data volume served by the second network device is greater than a data volume capacity of the second network device, activating at least one cell of the second network device.

In some embodiments, the at least one operation may comprise deactivating at least one cell of the second network device based on the information.

In some embodiments, the at least one operation may comprise: determining, using an energy cost model, first energy cost based on measurements from the terminal devices and the predicted data volume; determining second energy cost based on the predicted data volume and the first energy cost; based on determining that the second energy cost is improved, activating at least one cell of the second network device; and based on determining that the second energy cost is not improved, skip activating at least one cell of the second network device.

In some embodiments, the request may be indicative of at least one cell or beam of the second terminal device.

In some embodiments, the information may further comprise a number of the at least one terminal device, expected time when the at least one terminal device is offloaded from the first network device to the second network device, or any combination of two or more of the above-mentioned items.

With the process 800, improved resource management in network energy saving or mobility load balancing is enabled.

In some embodiments, an apparatus capable of performing any of the method 700 (for example, the network device 110) is provided. The apparatus may comprise means for performing the respective steps of the method 700. The means may be implemented in any suitable form. For example, the means may be implemented in a circuitry or software module.

In some embodiments, the apparatus comprises means for receiving, from a second network device, a request for information at least comprising predicted data volume associated with at least one terminal device to be on or on at least one trajectory from a cell associated with the first network device to a cell associated with the second network device; means for obtaining the information based on receiving the request; and means for transmitting the information to the second network device.

In some embodiments, means for obtaining the information may comprise means for determining, using a trajectory model, the at least one terminal device which is to be on or on the at least one trajectory among a plurality of terminal devices served by the first network device; and means for determining, using a data volume model, the information associated with the at least one terminal device.

In some embodiments, means for determining the at least one terminal device may comprise means for determining, for a terminal device among the plurality of terminal devices, whether a predicted trajectory of the terminal device is one of the at least one trajectory, and based on determining that the predicted trajectory of the terminal device may comprise means for being one of the at least one trajectory, determining that the terminal device is one of the at least one terminal device.

In some embodiments, the apparatus may further comprise means for obtaining mobility history information and visited cell/beam information on the terminal device; and means for determining the predicted trajectory of the terminal device by inputting the mobility history information and the visited cell/beam information into the trajectory model.

In some embodiments, means for determining the information may comprise means for obtaining the information by providing an output of the trajectory model into the data volume model as an input.

In some embodiments, the apparatus may further comprise means for determining, for a terminal device among the at least one terminal device, an individual predicted data volume based on the data volume model and traffic information of the terminal device, and means for determining the predicted data volume based on a sum of at least one individual predicted data volume of the at least one terminal device.

In some embodiments, the trajectory model may be deployed at one of a control plane (CP) of a centralized unit (CU) of the first network device, a user plane (UP) of the CU of the first network device, or a distributed unit (DU) of the first network device; and the data volume model may be deployed at another one of the CP of the CU of the first network device, the UP of the CU of the first network device, or the DU of the first network device.

In some embodiments, the apparatus may further comprise means for indicating, by the CP to the UP, the at least one terminal device determined based on the trajectory model; means for determining, at the UP, at least one individual predicted data volume of the at least one terminal device based on the data volume model; means for providing, by the UP to the CP, the at least one individual predicted data volume; and means for determining, at the CP, the predicted data volume by summing the at least one individual predicted data volume.

In some embodiments, the apparatus may further comprise means for indicating, by the CP to the UP, the at least one terminal device determined based on the trajectory model; means for determining, at the UP, at least one individual predicted data volume of the at least one terminal device based on the data volume model; and means for determining, at the UP, the predicted data volume by summing the at least one individual predicted data volume.

In some embodiments, an output of the trajectory model may be provided to the data volume model as an input via an E1 interface or an F1 interface.

In some embodiments, the trajectory model inference may be done based on mobility history information of a plurality of terminal devices; and the mobility history information of a terminal device may comprise visited cells/beams of the terminal device and time spent by the terminal device in each of the visited cells/beams.

In some embodiments, the data volume model inference may be done based on sets of data items of a plurality of trajectories; a set of data items of a trajectory may comprise at least a list of cells/beams, a list of terminal devices, a count of terminal devices, expected average time spent, expected total data volume, or expected average data volume at a future time instance; and the data volume model inference may be done to predict at least one of a count of active terminal devices or a data volume on a given trajectory at a given time.

In some embodiments, the apparatus may further comprise means for obtaining, from the request, at least one cell or beam of the second network device; and means for determining the at least one trajectory which is associated with (i) at least one cell or beam of the first terminal device and (ii) the at least one cell or beam of the second network device indicated in the request.

In some embodiments, the information may further comprise at least one of the following: a number of the at least one terminal device; or expected time when the at least one terminal device is offloaded from a cell associated with the first network device to a cell associated with the second network device.

In some embodiments, the request may be received via an Xn interface; or the information may be transmitted via an Xn interface.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing any of the method 800 (for example, the second network device 120) is provided. The apparatus may comprise means for performing the respective steps of the method 800. The means may be implemented in any suitable form. For example, the means may be implemented in a circuitry or software module.

In some embodiments, the apparatus comprises means for transmitting, to a first network device, a request for information at least comprising predicted data volume associated with at least one terminal device to be on or on at least one trajectory from a cell associated with the first network device to a cell associated with the second network device; means for receiving the information from the first network device; and means for applying the information.

In some embodiments, the apparatus may comprise means for transmitting the request based on at least one of the following: determining that at least one cell of the second network device is to be deactivated; or determining that at least one cell of the second network device is to be activated.

In some embodiments, means for applying the information may comprise means for performing, based on the information, at least one operation for at least one of cell activation, load balancing, or energy saving.

In some embodiments, the at least one operation may comprise: based on determining that a sum of the predicted data volume and a data volume served by the second network device is greater than a data volume capacity of the second network device, activating at least one cell of the second network device.

In some embodiments, the at least one operation may comprise: deactivating at least one cell of the second network device based on the information.

In some embodiments, the at least one operation comprises: determining, using an energy cost model, first energy cost based on measurements from the terminal devices and the predicted data volume; determining second energy cost based on the predicted data volume and the first energy cost; based on determining that the second energy cost is improved, activating at least one cell of the second network device; and based on determining that the second energy cost is not improved, skip activating at least one cell of the second network device.

In some embodiments, the request may be indicative of at least one cell or beam of the second terminal device.

In some embodiments, the information may further comprise at least one of the following: a number of the at least one terminal device; or expected time when the at least one terminal device is offloaded from the first network device to the second network device.

In some embodiments, the request may be received via an Xn interface; or the information may be transmitted via an Xn interface.

In some embodiments, the apparatus further comprises means for performing other steps in some example embodiments of the method 800. In some example embodiments, the means comprises at least one processor and at least one memory including computer program code, the at least one memory and computer program code configured to, with the at least one processor, cause the performance of the apparatus.

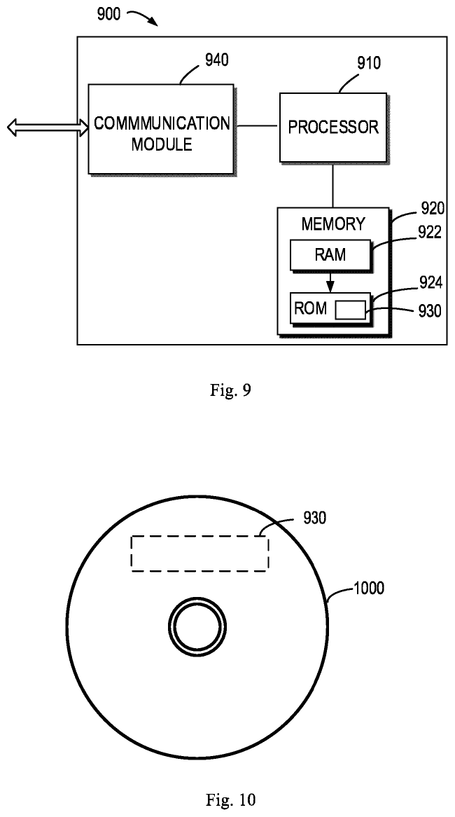

FIG. 9 is a simplified block diagram of a device 900 that is suitable for implementing embodiments of the present disclosure. The device 900 may be provided to implement the communication device, for example the first network device 110 and the second network device 120 as shown in FIG. 1A. As shown, the device 900 includes one or more processors 910, and one or more communication modules 940 coupled to the processor 910. The device 900 may further include one or more memories 920 coupled to the processor 910.

The communication modules 940 may be for bidirectional communications. The communication modules 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIGS. 2 to 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700 or 800 as described above with reference to FIG. 7-FIG. 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first network device comprising:
at least one processor; and
at least one memory storing instructions that, when executed by the at least one processor, cause the first network device at least to:
receive, from a second network device, a request for information at least comprising predicted data volume associated with at least one terminal device to be on or on at least one trajectory from a cell associated with the first network device to a cell associated with the second network device;
obtain the information based on receiving the request; and
transmit the information to the second network device.

2. The first network device of claim 1, wherein the first network device is caused to obtain the information by:
determining, using a trajectory model, the at least one terminal device which is to be on or on the at least one trajectory among a plurality of terminal devices served by the first network device; and
determining, using a data volume model, the information associated with the at least one terminal device.

3. The first network device of claim 2, wherein the first network device is caused to determine the at least one terminal device by:
determining, for a terminal device among the plurality of terminal devices, whether a predicted trajectory of the terminal device is one of the at least one trajectory; and
based on determining that the predicted trajectory of the terminal device is one of the at least one trajectory, determining that the terminal device is one of the at least one terminal device.

4. The first network device of claim 3, wherein the first network device is further caused to:
obtain mobility history information and visited cell/beam information on the terminal device; and
determine the predicted trajectory of the terminal device by inputting the mobility history information and the visited cell/beam information into the trajectory model.

5. The first network device of any of claims 2-4, wherein the first network device is caused to determine the information by:
obtaining the information by providing an output of the trajectory model into the data volume model as an input.

6. The first network device of claim 5, wherein the first network device is further caused to:
determine, for a terminal device among the at least one terminal device, an individual predicted data volume based on the data volume model and traffic information of the terminal device; and
determine the predicted data volume based on a sum of at least one individual predicted data volume of the at least one terminal device.

7. The first network device of claim 2, wherein:
the trajectory model is deployed at one of a control plane (CP) of a centralized unit (CU) of the first network device, a user plane (UP) of the CU of the first network device, or a distributed unit (DU) of the first network device; and
the data volume model is deployed at another one of the CP of the CU of the first network device, the UP of the CU of the first network device, or the DU of the first network device.

8. The first network device of claim 7, wherein the first network device is further caused to:
indicate, by the CP to the UP, the at least one terminal device determined based on the trajectory model;
determine, at the UP, at least one individual predicted data volume of the at least one terminal device based on the data volume model;
provide, by the UP to the CP, the at least one individual predicted data volume; and
determine, at the CP, the predicted data volume by summing the at least one individual predicted data volume.

9. The first network device of claim 7, wherein the first network device is further caused to:
indicate, by the CP to the UP, the at least one terminal device determined based on the trajectory model;
determine, at the UP, at least one individual predicted data volume of the at least one terminal device based on the data volume model; and
determine, at the UP, the predicted data volume by summing the at least one individual predicted data volume.

10. The first network device of any of claim 7-9, wherein an output of the trajectory model is provided to the data volume model as an input via an E1 interface or an F1 interface.

11. The first network device of any of claims 2-10, wherein:
a trajectory model inference is done based on mobility history information of a plurality of terminal devices; and
the mobility history information of a terminal device comprises visited cells/beams of the terminal device and time spent by the terminal device in each of the visited cells/beams.

12. The first network device of any of claims 2-11, wherein:
a data volume model inference is done based on sets of data items of a plurality of trajectories;
a set of data items of a trajectory comprise at least one of a list of cells/beams, a list of terminal devices, a count of terminal devices, expected average time spent, expected total data volume, expected average data volume at a future time instance; and
the data volume model inference is done to predict at least one of a count of active terminal devices or a data volume on a given trajectory at a given time.

13. The first network device of any of claims 1-12, wherein the first network device is further caused to:
obtain, from the request, at least one cell or beam of the second network device; and
determine the at least one trajectory which is associated with (i) at least one cell or beam of the first terminal device and (ii) the at least one cell or beam of the second network device indicated in the request.

14. The first network device of any of claims 1-13, wherein the information further comprises at least one of the following:
a number of the at least one terminal device; or
expected time when the at least one terminal device is offloaded from a cell associated with the first network device to a cell associated with the second network device.

15. The first network device of any of claims 1-14, wherein at least one of the following:
the request is received via an Xn interface; or
the information is transmitted via an Xn interface.

16. A second network device comprising:
at least one processor; and
at least one memory storing instructions that, when executed by the at least one processor, cause the second network device at least to:
transmit, to a first network device, a request for information at least comprising predicted data volume associated with at least one terminal device to be on or on at least one trajectory from a cell associated with the first network device to a cell associated with the second network device;
receive the information from the first network device; and
apply the information.

17. The second network device of claim 16, wherein the second network device is caused to transmit the request based on at least one of the following:
determining that at least one cell of the second network device is to be deactivated; or
determining that at least one cell of the second network device is to be activated.

18. The second network device of claim 16 or 17, wherein the second network device is caused to apply the information by:
performing, based on the information, at least one operation for at least one of cell activation, load balancing, or energy saving.

19. The second network device of claim 18, wherein the at least one operation comprises:
based on determining that a sum of the predicted data volume and a data volume served by the second network device is greater than a data volume capacity of the second network device, activating at least one cell of the second network device.

20. The second network device of claim 18, wherein the at least one operation comprises:
deactivating at least one cell of the second network device based on the information.

21. The second network device of claim 18 or 19, wherein the at least one operation comprises:
determining, using an energy cost model, first energy cost based on measurements from the terminal devices and the predicted data volume;
determining second energy cost based on the predicted data volume and the first energy cost;
based on determining that the second energy cost is improved, activating at least one cell of the second network device; and
based on determining that the second energy cost is not improved, skip activating at least one cell of the second network device.

22. The second network device of any of claims 16-21, wherein the request is indicative of at least one cell or beam of the second terminal device.

23. The second network device of any of claims 16-22, wherein the information further comprises at least one of the following:
a number of the at least one terminal device; or
expected time when the at least one terminal device is offloaded from the first network device to the second network device.

24. The second network device of any of claims 16-23, wherein at least one of the following:
the request is received via an Xn interface; or
the information is transmitted via an Xn interface.

25. A method comprising:
receiving, at a first network device from a second network device, a request for information at least comprising predicted data volume associated with at least one terminal device to be on or on at least one trajectory from a cell associated with the first network device to a cell associated with the second network device;
obtaining the information based on receiving the request; and
transmitting the information to the second network device.

26. A method comprising:
transmitting, at a second network to a first network device, a request for information at least comprising predicted data volume associated with at least one terminal device to be on or on at least one trajectory from a cell associated with the first network device to a cell associated with the second network device;
receiving the information from the first network device; and
applying the information.

27. An apparatus comprising:
means for receiving, from a network device, a request for information at least comprising predicted data volume associated with at least one terminal device to be on or on at least one trajectory from a cell associated with the apparatus to a cell associated with the network device;
means for obtaining the information based on receiving the request; and
means for transmitting the information to the network device.

28. An apparatus comprising:
means for transmitting, to a network device, a request for information at least comprising predicted data volume associated with at least one terminal device to be on or on at least one trajectory from a cell associated with the network device to a cell associated with the s apparatus;
means for receiving the information from the network device; and
means for applying the information.

29. A non-transitory computer readable medium comprising program instructions that, when executed by an apparatus, cause the apparatus to perform at least the method of claim 25 or 26.
